(19) United States
(12) Patent Application Publication
(10) Pub. No.: US 2011/0314638 A1
(43) Pub. Date: Dec. 29, 2011

(54) Apparatus For Twist-Free Handling Of Two Leashes

(76) Inventors: Frank Patt, Meinerzhagen (DE); Tobias Martin, Olpe (DE)

(21) Appl. No.: 13/115,484

(22) Filed: May 25, 2011

(30) Foreign Application Priority Data
May 27, 2010 (DE) 10 2010 017 124

(51) Int. Cl. B25G 1/10

(52) U.S. Cl. 16/421

(57) ABSTRACT

The invention relates to an apparatus for twist-free handling of two leashes, in particular dog leashes, having a grip part onto which a rotor is rotatably or pivotably coupled, the rotor receiving the two leashes. According to the present invention, an apparatus of this kind is characterized in that the rotor comprises two receptacles into each of which is insertable a housing of a retractable leash that receives the leash; and that the retractable leashes are replaceably fastenable in the receptacles by means of retaining pieces. With such an apparatus, commercially usual retractable leashes can be fastened exchangeably in the receptacles.

The present invention relates to an apparatus for twist-free handling of two leashes, in particular dog leashes, having a grip part onto which a rotor is rotatably or pivotably coupled, the rotor receiving the two leashes.

An apparatus of this kind is known from DE 10 2007 010 294 A1. Here the grip part is coupled to the rotor via a rotary bearing. The rotor is embodied as a housing that receives two leashes. The leashes can be pulled out of the housings against the pre-tension of a coil spring. When the leashes are released, they are taken back in by the coil spring. An electric motor, which can be switched selectably by control buttons to rotate to the left or the right, is held in the grip part. When two dogs are walked using the known apparatus, it occasionally happens that the paths of the two dogs cross. The leashes thus also cross. In order to eliminate this twisting, the electric motor is activated and the rotor is turned in the desired rotation direction.

An apparatus operating on a similar principle is also known from WO 2006/099431 A1.

It is an object of the invention to make available an apparatus for twist-free handling of two leashes that is notable for a simple configuration and improved handling.

This object is achieved in that the rotor comprises two receptacles into each of which is insertable a housing of a retractable leash that receives the leash; and the retractable leashes are replaceably fastenable in the receptacles by means of retaining pieces. It is thus possible to use as a retractable leash commercially usual dog leashes that, in a housing, comprise a leash, a return spring for rewinding the leash after it has been pulled out, and usually an immobilizing mechanism to block the extraction motion of the leash. Retractable leashes of this kind are economically obtainable commercially in a variety of embodiments. According to the present invention, these retractable leashes can each be inserted into a receptacle of the rotor, and fastened by means of the retaining pieces. The apparatus is thus immediately ready for operation. Dog walkers usually already possess the known commercially usual retractable leashes, so they can insert them without additional outlay directly into the receptacle.

When a retractable leash becomes defective after an extended period of use, it can easily be removed and replaced with a new one.

According to a preferred variant embodiment of the invention, provision can be made that the rotor comprises support surfaces against which the housings of the retractable leash are abuttable; and the support surfaces are arranged equidistantly with respect to the rotation axis of the rotor. The retractable leashes are fastened in defined fashion against the support surfaces. Because the support surfaces are arranged equidistantly with respect to the rotation axis of the rotor, transverse forces from the two pulling dogs are minimized. Handling is thereby considerably improved.

Quick and simple fastening of the retractable leashes is possible, in particular, when the rotor comprises a clamping part that forms part of the receptacles, and that is displaceable by means of a slide guide relative to at least one of the retaining pieces. A clamped connection can be produced quickly and simply in this fashion. Reliable positive securing of the retractable leashes is achieved in simple fashion when provision is made that the clamping part comprises a holding shell for partial enclosure of the housing of the retractable leash. A simple design for the rotor results when provision is made that the rotor comprises a connecting segment that encompasses a flange, the flange being nonrotatably coupled onto a coupling piece of the grip part.

Provision can be made according to the present invention that at least some of the retaining pieces comprise a sliding seat for setting different retaining positions. Adaptation to different retractable leashes can thereby be individually performed.

Operation of the apparatus according to the present invention can be further improved by the fact that the grip part comprises a leash activator; the leash activator comprises two actuation extensions that are each associated with one receptacle; and the leash activator is displaceable in or on the grip part between a locked position and an unlocked position. Disengagement or retention of the two leashes can thus be performed centrally on the grip part. In this context, the leash activator acts on the activation buttons of the two retractable leashes.

It is particularly advantageous in this context if provision is made that the leash activator is coupled in the grip part onto a manually operable actuation part; and the leash activator is held in the unlocked position in spring-preloaded fashion by means of a spring element. As is usual with ordinary retractable leashes, the leash is by default free to run out, and can be actively locked by actuating the leash activator against the spring preload.

The object of the invention is also achieved in that the grip part receives a positioning unit that comprises a rotary piece coupled onto the rotor, the rotary piece being rotatable or pivotable selectably clockwise or counterclockwise by means of an actuation unit; and the actuation unit is displaceable by means of a handle between two positions in order to generate the rotary or pivoting motion. With this arrangement, a shift of the actuation unit is brought about upon operation of the handle. This positioning motion is converted into a rotary motion that can then be passed on to the rotary piece on the rotor. As soon as a user ascertains a twisting of the leashes, he or she can thus easily manually produce, by actuation of the handle, a rotation of the rotor and thus a correction of the leash position.

Provision can be made in particular, in this context, that the rotary piece is coupled onto a shaft that comprises two opposite-direction threads; each thread receives an internal thread of a transfer part; and the transfer parts are alternately couplable to the actuation unit as a function of the desired rotation direction. Right-left pivotability of the rotor is thereby obtained with a simple design and little physical complexity.

This transfer mechanism is moreover still reliably functional even when both dogs are pulling on the two leashes.

A preferred variant of the invention is such that the grip part comprises a rotation direction selector switch that is displaceable on the grip part, by means of a handle, between two switch positions associated with the respective rotation directions. In this fashion, the user can perform a switchover as a function of the twist direction, and can conveniently set the rotation direction of the rotor from the grip part.

An apparatus according to the present invention can be characterized in that the actuation unit is held, preloaded by means of a preload spring, in one position; that the actuation unit is movable out of that position into the second position, accompanied by generation of the rotary or pivoting motion; and that the actuation unit is movable by means of the preload spring out of the second position into the first, in which context the rotary piece is not rotated. Automatic return of the actuation unit after an actuation of the rotor is thereby brought about, resulting in improved operating convenience.

The invention will be further explained below with reference to exemplifying embodiments depicted in the drawings, in which:

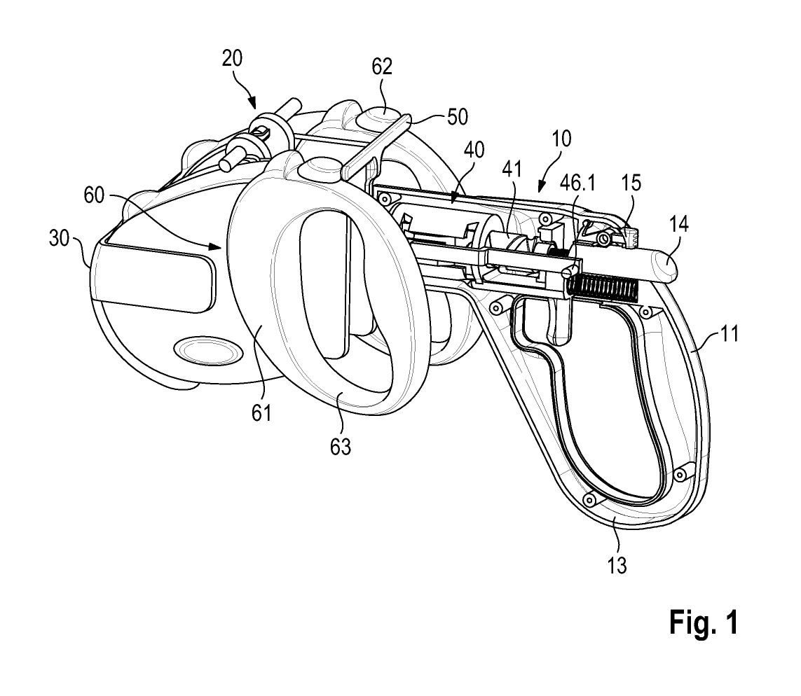

FIG. 1 is a perspective depiction of an apparatus for twist-free handling of two leashes, having two retractable leashes;

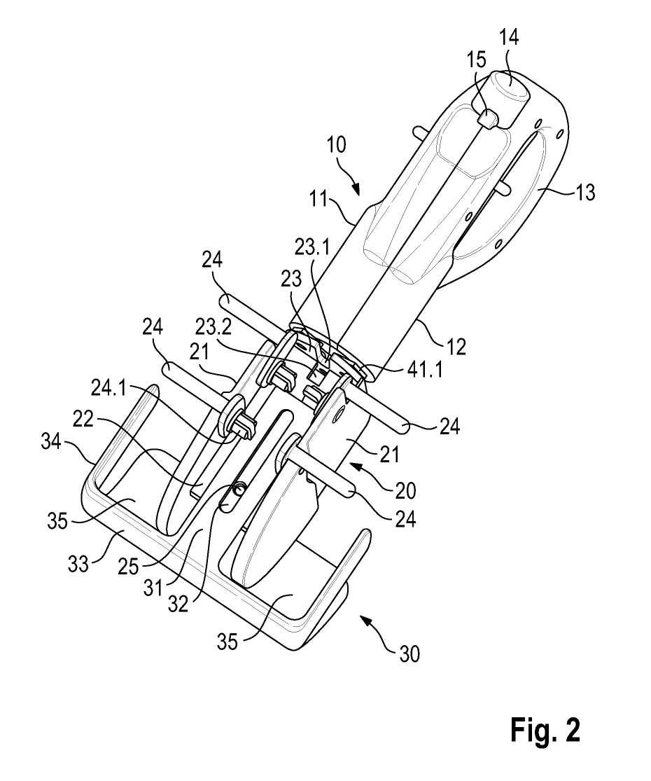

FIG. 2 is a perspective view of what is depicted in FIG. 1, but without retractable leashes;

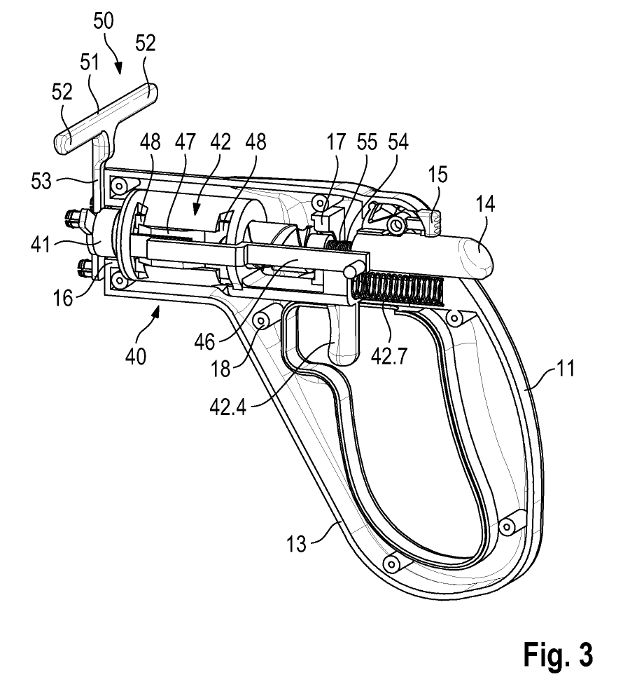

FIG. 3 is a perspective interior view of a grip part of the apparatus according to FIG. 2;

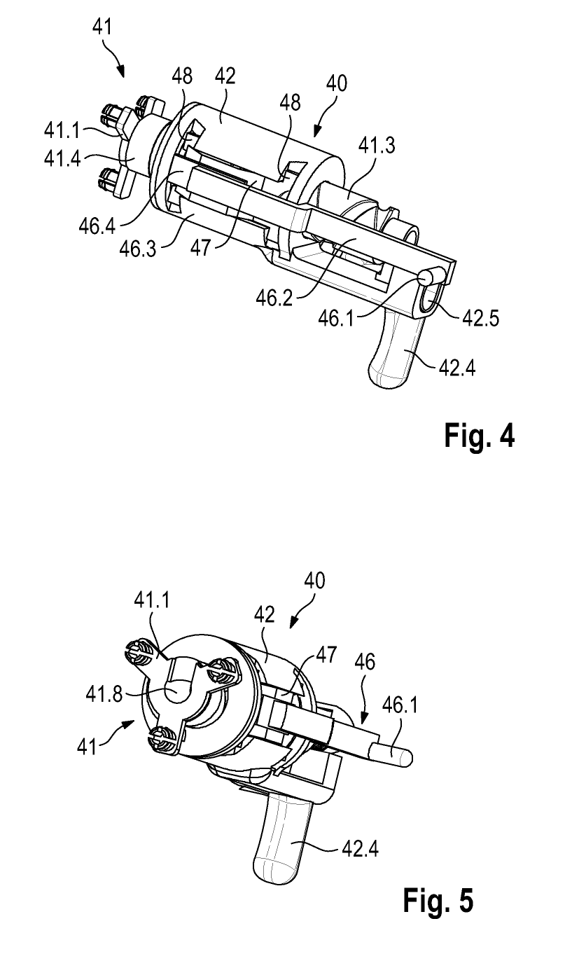

FIG. 4 is a perspective side view of a positioning unit;

FIG. 5 is a perspective view, from below, of the positioning unit according to FIG. 4; and

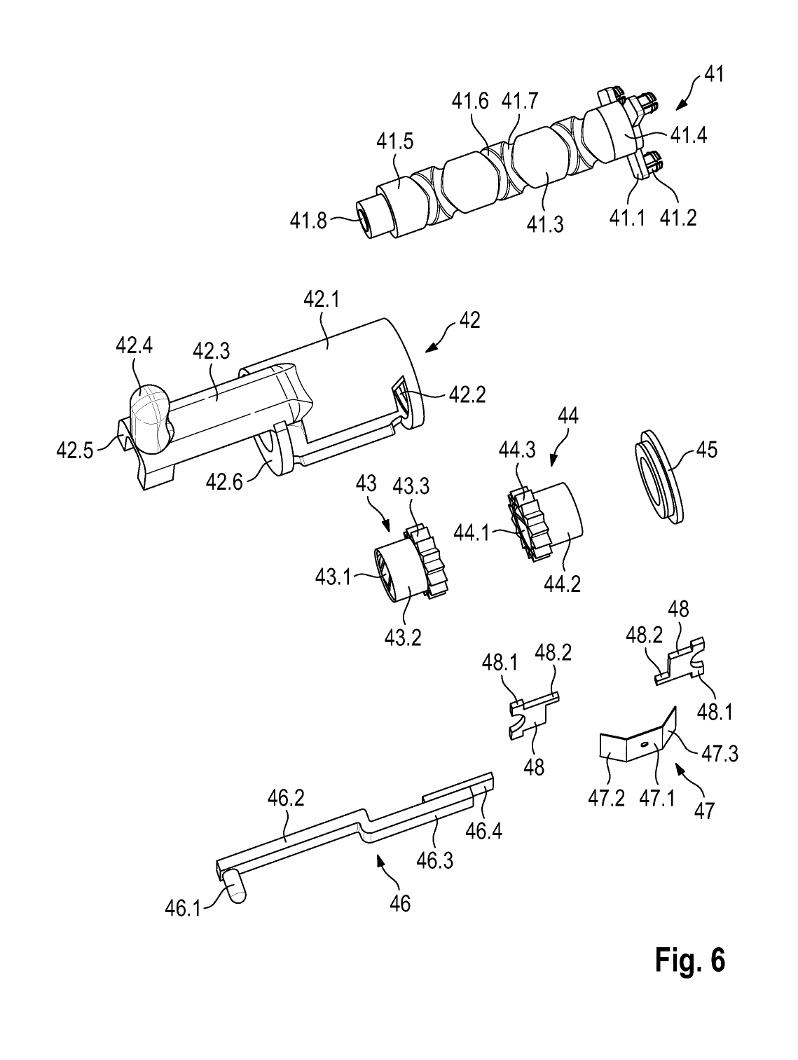

FIG. 6 is an exploded view of the positioning unit according to FIGS. 4 and 5.

As FIGS. 1 and 2 show, the apparatus for twist-free handling of two leashes comprises a grip part 10 and a rotor 20 rotatably coupled thereonto. Grip part 10 encompasses two housing shells 11, 12 that form a grip 13. An actuation part 14 in the form of a button is accommodated in linearly displaceable fashion in the housing. Actuation part 14 can be retained, by means of an immobilizing piece 15, in the position pushed into the housing.

Rotor 20 is mounted with a flange 23 on a rotary piece 41.1 of grip part 10. Rotary piece 41.1 comprises for this purpose dowel-like mounting elements 41.2 that are snapped into orifices of flange 23. A connecting segment 22 is shaped integrally onto flange 23. In an alternative variant embodiment connecting segment 22 can also, for stability reasons and in order to reduce part complexity, be connected integrally to rotary piece 41.1 and can form one module together with a shaft 41 to be described in further detail later with reference to FIG. 6. Connecting segment 22 is plate-shaped, and carries two wall elements, spaced apart parallel to one another, that form external support surfaces 21. A clamping part 30 can be mounted on connecting segment 22. Clamping part 30 comprises a plate-shaped extension 31 into which an elongated hole is incorporated as slide guide 32. Extension 31 is placed onto connecting segment 22. A screw (not depicted), which is passed through slide guide 32 and screwed into a threaded receptacle 25 of connecting segment 22, is used to secure clamping part 30 on connecting segment 22. In the assembled state, the mounting screw clamps extension 31 onto connecting segment 22. Clamping part 30 is also adjustable in width, thereby ensuring that the leashes are fixedly enclosed. Clamping part 30 carries a holding shell 33 on extension 31. Said shell is embodied in a manner adapted to the contour of housing 61 of retractable leash 60, as shown clearly in FIG. 1. Commercially usual dog leashes that carry a coiled-up dog leash in housing 61 are used as retractable leashes 60; the dog leash can be pulled out of housing 61 against the preload of a spring. When the dog leash is released, it is coiled back into housing 61 by means of the spring. Retractable leash 60 further encompasses an immobilizing button 62. When immobilizing button 62 is in the default position shown in FIG. 1, the dog leash is disengaged and can thus be pulled out. When immobilizing button 62 is pushed, retractable leash 60 is immobilized and the dog leash cannot be pulled farther out.

Rotor 20 encompasses two receptacles 35, into each of which one of the commercially usual retractable leashes can be inserted. Retaining pieces 24 are used to secure housings 61 of retractable leashes 60. Retaining pieces 24 comprise a stud-shaped extension that is fastened on a carrier plate. The carrier plate is equipped with an elongated hole through which a mounting screw 24.1 is passed and is screwed into a threaded receptacle of side part 21. Retaining pieces 24 can thus both be pivoted around the longitudinal center axis of mounting screws 24.1, and axially displaced in the elongated-hole direction. In this fashion, retaining pieces 24 can be adapted to different geometries of retractable leashes 60. In order to secure retractable leashes 60, retaining pieces 24 are placed against housing 61 and then mounting screws 24.1 are tightened. The two retaining pieces 24 (not visible in FIG. 1) engage into the region of grip opening 63 of housing 61, and are placed there against the housing wall. In order to prevent retractable leashes 60 from sliding laterally, side parts 34 that abut laterally against housing 61 are shaped integrally onto holding shell 33. For final or additional securing, a rubber gripper is tensioned around housings 61 of retractable leashes 60 in such a way that the latter are pulled against side parts 21 in response to the strap tension, and reliably held in position.

FIG. 3 is an opened depiction of grip part 10, grip shell 12 having been taken off. As is evident from this depiction, a positioning unit 40 is inserted into grip part 10. Positioning unit 40 is further detailed in FIGS. 4 to 6, different views of the assembled positioning unit 40 being shown respectively in FIGS. 4 and 5.

The configuration of positioning unit 40 will now be further explained with reference to FIG. 6. As is evident from this depiction, positioning unit 40 comprises a shaft 41 onto which rotary piece 41.1 is integrally coupled. As is evident from this depiction, mounting elements 41.2 for the attachment of rotor 20 are also shaped integrally onto rotary piece 41.1. Adjoining rotary piece 41.1, shaft 41 comprises a bearing 41.4 in the form of a cylindrical collar. A further bearing 41.5 in the form of a cylindrical collar is provided at the opposite shaft end. Between the two bearings 41.4 and 41.5, shape 41 forms a cylindrical guidance surface 41.3. Two threads 41.6 and 41.7 are recessed into this guidance surface 41.3. One thread 41.6, 41.7 is designed to be right-handed, the other thread left-handed. Shaft 41 is embodied as a hollow shaft, and accordingly comprises a lumen 41.8.

An actuation unit 42 can be coupled to shaft 41. Actuation unit 42 possesses a housing 42.1 that surrounds a receptacle 42.2. A handle 42.4 is shaped onto housing 42.1 via an extension 42.3 in the shape of an arm. Extension 42.3 forms a spring receptacle 42.5 on handle 42.4. Two transfer parts 43 can be incorporated into housing 42.1. Transfer parts 43 comprise a peg 43.2 and a gear 43.3 shaped integrally thereonto. Gear 43.3 comprises teeth that comprise in the circumferential direction a continuously rising deflection ramp that transitions into a steep locking flank. The steep locking flank extends substantially radially with respect to the longitudinal center axis of transfer parts 43. The two transfer parts 43 and 44 each comprise an internal thread 43.1, 44.1. This internal thread 43.1, 44.1 is embodied in such a way that it coacts with thread 41.6 and 41.7, respectively, of shaft 41. The two transfer parts 43 and 44 are inserted into housing 42.1; the two transfer parts 43, 44 rest against one another with their two gears 43.3 and 44.3. The two transfer parts 43 and 44 can easily be inserted into housing 42.1 through an orifice-shaped receptacle 42.2. A thrust washer 45 is used to hold the two transfer parts 43, 44 in lossproof fashion. Said washer is slid laterally into housing 42.1 so that it braces peg 44.2 of second transfer part 44 in rotationally guided fashion behind receptacle 42.2. The subassembly thus constituted can be slid onto shaft 41. In this context, shaft 41, beginning with its bearing 41.5, is slid through receptacle 42.2 (or thrust washer 45). Internal threads 44.1 and 43.1 of the two transfer parts 43 and 44 then come into engagement with the thread 41.6 and 41.7 that respectively fits them. Lastly, shaft 41 is slid with its bearing 41.5 through an orifice in a support shoulder 42.6 until the physical state shown in FIGS. 4 and 5 is established.

Rotation direction selector switch 46 is located on both sides of the housing so that it can be operated by right- and left-handed people.

Two claws 48 are then inserted into a lateral slot of housing 42.1. Claws 48 comprise a support shoulder 48.1 and, located opposite it, an immobilizing piece 48.2. Claws 48 are inserted into housing 42.1 so that the immobilizing pieces come into engagement with the tooth sets of gears 43.3, 44.3. Support shoulder 48.1 is braced internally against support shoulder 42.6, and internally against thrust washer 45. A switch piece 47 is used to secure the two claws 48. Switch piece 47 comprises a base part 47.1 from which two plate-shaped end pieces 47.2 are bent out. Plate-shaped end pieces 47.2 rest externally on claws 48. A rotation direction selector switch 46 is fixedly connected to switch piece 47. Rotation direction selector switch 46 comprises a handle 46.1 onto which a limb 46.2 is coupled. Limb 46.2 is adjoined, via a cranked bend, by a further limb 46.3. Oppositely from handle 46.1, rotation direction selector switch 46 comprises an end piece 46.4. This end piece 46.4 is connected fixedly to base part 47.1 of switch piece 47. The association of rotation direction selector switch 46 with positioning unit 40 and with claws 48 may be gathered in more detail from FIGS. 4 and 5, respectively. Rotation direction selector switch 46 can be displaced linearly in the longitudinal direction of its limbs 46.2, 46.3. In a first switch position, end piece 47.2 rests on the left-side (in FIG. 4) claw 48, and retains it nondisplaceably in the radial direction of shaft 41. Second claw 48, on the other hand, is disengaged from end piece 47.3 of switch piece 47. It can therefore be displaced in limited fashion in the radial direction of shaft 41, and upon a rotation of the shaft is deflected radially outward on the deflection ramps of gear 44.3 of transfer part 44 so that transfer part 44 can rotate freely. In this switch position, second claw 48 is blocked so that it immobilizes transfer part 43. In particular, immobilizing piece 48.2 cannot be deflected on the deflection ramps of gear 43.3. When the switch position of the rotation direction selector switch is changed, transfer part 44 is then immobilized and transfer part 43 is disengaged. Before the subassembly depicted in FIGS. 4 and 5 is inserted into housing part 11 (shown in FIG. 3), a leash activator 50 is additionally installed. This leash activator 50 comprises a bar-shaped carrier 51 that comprises actuation extensions 52 at both of its ends. Carrier 51 is coupled via a transition element 53 to a slider 54. Slider 54 is rod-shaped, and is slid through lumen 41.8 of shaft 41. As is evident from FIG. 3, adjacent to shaft 41 slider 54 is fitted with a slid-on preload spring 55. Preload spring 55 is fastened on slider 54 by means of a suitable mounting element, for example a shaft retaining ring. Slider 54 is slid with its free end into a receptacle of actuation part 14. As FIG. 3 shows, positioning unit 40 can be placed into housing shell 11. Second housing shell 12 is then placed over it. Mounting screws are passed through screw receptacles of second housing shell 12, and screwed into screw bosses 18 of first housing shell 11. This completes grip part 10.

The manner of operation of the grip part will now be further explained with reference to FIG. 3. In the depiction according to FIG. 3, rotation direction selector switch 46 is held in its front position. It then blocks claw 48 depicted at the left in FIG. 3, while the right-side claw 48 is disengaged. This blockage causes the left transfer part 43 to be coupled nonrotatably to actuation unit 42. If actuation unit 42 is then pulled backward at handle 42.4 (like a gun trigger), this sliding motion is transferred in transfer part 43 to shaft 41 in such a way that a rotary motion is imparted thereto. The right-side transfer part 44 is passively carried along, in free-running fashion, on shaft 41. The threaded connection between threads 41.6 and 41.7 of shaft 41, and internal threads 43.1 and 44.1 of transfer parts 43 and 44 respectively, is selected so that upon a manual actuation of handle 42.4 from its first position into the second position, a 180-degree rotation of shaft 41 is brought about. When handle 42.4 is released after an actuation, a preload spring 42.7, which engages into spring receptacle 42.5 of housing 42.1 and is braced with respect to housing part 11, pushes actuation unit 42 back into the initial position shown in FIG. 3. When rotation direction selector switch 46 is in the position shown in FIG. 3, a clockwise rotation of rotor 20 is produced when handle 42.4 is pulled. If rotation direction selector switch 46 is then shifted into the other switch position, switch piece 47 then comes into engagement with the right-side claw 48 and blocks it against transfer part 44. The left-side transfer part 43 is then disengaged. In this switch position, when handle 42.4 is then pulled, transfer part 44 brings about a counterclockwise rotation of rotary piece 41.1 by way of the oppositely rotating threaded connection.

The function of leash activator 50 will now be further described. When actuation part 14 is pushed, slider 54 of leash activator 50 is linearly displaced against the preload of preload spring 55. The two actuation extensions 52 then simultaneously press onto immobilizing buttons 62 of retractable leashes 60 (see FIG. 1). Both leashes are thus simultaneously immobilized with one actuation of actuation part 14. This immobilized position can be temporarily locked in place with immobilizing piece 15. When immobilizing piece 15 is unlocked, immobilizing buttons 62 and leash activator 50 then move back, and the retractable leashes are once again free-running.

In practical use, one dog is attached to each of the two leashes of retractable leashes 60. If the paths of the two dogs then cross, the leashes become twisted. The user then determines whether a clockwise or counterclockwise rotation is needed in order to untwist the leashes. He or she selects the rotation direction accordingly, using rotation direction selector switch 46. He or she then actuates handle 42.4, thereby pulling on actuation unit 42. As a result, rotor 20 is rotated 180 degrees in the desired direction so that the leashes are untwisted again.

What is claimed is:

1. An apparatus for twist-free handling of two retractable leashes, comprising:
a grip part;
a rotor rotatably coupled to the grip part, the rotor including first and second receptacles configured to receive housings of the first and second retractable leashes; and
first and second retaining pieces configured to fasten the first and second retractable leashes in the first and second receptacles, so that the retractable leashes can be replaceably fastened in the receptacles.

2. The apparatus according to claim 1, wherein:
the rotor comprises support surfaces against which the housings of the retractable leashes are abuttable; and
the support surfaces are arranged equidistantly with respect to a rotation axis of the rotor.

3. The apparatus according to claim 1, wherein:
the rotor includes a clamping part forming part of the receptacles, the clamping part including a slide guide configured such that the clamping part is displaceable relative to at least one of the retaining pieces.

4. The apparatus according to claim 3, wherein:
the clamping part comprises a holding shell configured to partially enclose the housings of the retractable leashes.

5. The apparatus according to claim 1, wherein:
the grip part includes a coupling piece; and
the rotor comprises a connecting segment including a flange, the flange being nonrotatably coupled onto the coupling piece of the grip part.

6. The apparatus according to claim 1, wherein:
at least one of the retaining pieces comprises a sliding seat for setting different retaining positions.

7. The apparatus according to claim 1, wherein:
the grip part comprises a leash activator;
the leash activator comprises two actuation extensions each associated with one of the receptacles; and
the leash activator is displaceable relative to the grip part between a locked position and an unlocked position.

8. The apparatus according to claim 7, further comprising:
a manually operable actuation part received in the grip part and coupled to the leash activator; and
a spring element biasing the leash activator toward the unlocked position.

9. The apparatus according to claim 1, further comprising:
a positioning unit received in the grip part, the positioning unit including:
a rotary piece coupled to the rotor; and
an actuation unit connected to the rotary piece and configured to rotate the rotary piece selectively clockwise or counterclockwise, the actuation unit including a handle manually movable between first and second positions to generate the rotation of the rotary piece.

10. The apparatus according to claim 9, wherein:
the actuation unit includes:
a shaft including two opposite-direction threads, the shaft being coupled to the rotary piece; and
first and second transfer parts each having an internal thread, the two opposite-direction threads of the shaft being received in the internal threads of the transfer parts; and
wherein the actuation unit is configured to alternately couple the first and second transfer parts to the shaft in response to selection of the clockwise or counter clockwise rotation of the rotary piece.

11. The apparatus according to claim 9, further comprising:
a rotation direction selector switch configured to select between the clockwise and counterclockwise rotation of the rotary piece.

12. The apparatus according to claim 9, wherein:
the actuation unit includes a preload spring biasing the handle towards the first position; and
the actuation unit is configured to rotate when the handle is moved from the first position to the second position, and not to rotate when the preload spring moves the handle from the second position back to the first position.

13. An apparatus for twist-free handling of two leashes, comprising:
a grip part;
a positioning unit received in the grip part, the positioning unit including a rotary piece, and an actuation unit connected to the rotary piece and configured to rotate the rotary piece selectively clockwise or counterclockwise, the actuation unit including a handle manually movable between first and second positions to generate the rotation of the rotary piece; and
a rotor coupled to the rotary piece, the rotor being configured to receive the two leashes.

14. The apparatus according to claim 13, wherein:
the actuation unit includes:
a shaft including two opposite-direction threads, the shaft being coupled to the rotary piece; and
first and second transfer parts each having an internal thread, the two opposite-direction threads of the shaft being received in the internal threads of the transfer parts; and
wherein the actuation unit is configured to alternately couple the first and second transfer parts to the shaft in response to selection of the clockwise or counter clockwise rotation of the rotary piece.

15. The apparatus according to claim 13, further comprising:
a rotation direction selector switch configured to select between the clockwise and counterclockwise rotation of the rotary piece.

16. The apparatus according to claim 13, wherein:
the actuation unit includes a preload spring biasing the handle towards the first position; and
the actuation unit is configured to rotate when the handle is moved from the first position to the second position, and not to rotate when the preload spring moves the handle from the second position back to the first position.
